(19) United States
(12) Patent Application Publication
(10) Pub. No.: US 2022/0333692 A1
(43) Pub. Date: Oct. 20, 2022

(54) SILENT EXHAUST VALVE

(71) Applicant: FAURECIA SYSTEMES D'ECHAPPEMENT, Nanterre (FR)

(72) Inventors: Raphaël DE MATOS, Saone (FR); Maxime ESNAULT, Colombier Fontaine (FR)

(21) Appl. No.: 17/720,388

(22) Filed: Apr. 14, 2022

(30) Foreign Application Priority Data
Apr. 16, 2021 (FR) 21 03954

(51) Int. Cl. F16K 1/226; F16K 1/22; F16K 27/02

(52) U.S. Cl. CPC F16K 1/226; F16K 1/222; F16K 27/0218; F02M 26/70

(57) ABSTRACT

An exhaust valve comprises a substantially tubular body extending along an extension axis, a substantially flat flap, and a shaft integral with the flap and rotatable about a rotation axis between a closed orientation and an open orientation. The exhaust valve further includes a first seat suitable for accommodating a first edge of the flap facing the first seat, and a second seat suitable for receiving a second opposing edge of the flap. In each plane passing through the extension axis, a distal end of a profile of a seat is curved in the direction of the opposing edge until the distal end comes into contact with the opposing edge. A distal end of a profile of an edge is curved in the direction of the opposing seat until the distal end comes into contact with the seat.

### CROSS-REFERENCE TO RELATED APPLICATIONS

This application is a U.S. non-provisional application claiming the benefit of French Application No. 2103954, filed on Apr. 16, 2021, which is incorporated herein by reference in its entirety.

### TECHNICAL FIELD

The disclosure relates to an exhaust valve, such as that used in an exhaust line downstream of an internal combustion engine. Such a valve may typically be used:
in connection with tapping a pipe, to selectively take at least a portion of the exhaust gases to a circuit for recirculation or exhaust gas recirculation (EGR),
as a bypass, to direct all or part of the exhaust gases to a heat recovery device, another circuit, or a sound attenuation device,
as a device for generating back pressure for acoustic purposes.

### BACKGROUND

It is known to provide an exhaust valve, comprising a substantially tubular body, extending along an extension axis, defining a passage section substantially perpendicular to the extension axis. Such a valve further comprises a substantially planar flap, arranged in the body across the passage section, having a flap section totally within the passage section. Such a valve also comprises a shaft, integral with the flap, and which is rotatable about a rotation axis that passes through the body and is substantially perpendicular to the extension axis. The flap is rotatable between a closed orientation, in which the flap is arranged substantially perpendicular to the extension axis so as to close off the passage section, and an open orientation in which the flap is not substantially perpendicular to the extension axis so as to release the passage section, at least partially.

Such a valve further comprises a first and a second seat. The first seat is integral with the body, substantially hemi-annular in shape about the extension axis, and extends angularly substantially from a first end of the shaft to a second end of the shaft in a trigonometric direction. The first seat is delimited by the passage section on the outside and by a seat section totally within the flap section on the inside. The second seat is integral with the body, substantially hemi-annular in shape about the extension axis, and extends angularly from the second end of the shaft to the first end of the shaft in the trigonometric direction. The second seat is delimited by the passage section on the outside and by the seat section on the inside.

Such a valve further comprises a first and a second hemi-annular edge of the flap. The first seat is adapted to receive the first hemi-annular edge of the flap opposite, in closed orientation. This first edge is arranged on a first face of the flap. The second seat is adapted to receive the second facing edge, in closed orientation. This second edge is arranged on a second face of the flap, opposite the first face.

Such a valve generally has the disadvantage of producing noise caused by the impact of an edge against the facing seat, mainly in closed orientation. The noise is all the more important as the seal between the edge and the seat is weak. Therefore, one way to reduce the noise is to reduce the leakage between edge and seat.

A first way to reduce leakage is to use compliant materials such as elastomer to make a seal. Such a solution is impossible here because of the very high temperatures encountered in an exhaust pipe, of the order of 600° C. to 900° C.

Another way is to make finely fitted parts, edge and/or seat. This requires very precise parts, generally produced by machining, leading to high costs, which should be avoided.

Also, the disclosure aims at proposing an exhaust valve, simple to implement and inexpensive, making greater sealing possible, so as to reduce the noise.

### SUMMARY

The subject disclosure provides an exhaust valve comprising a substantially tubular body that extends along an extension axis and defines a passage section that is substantially perpendicular to the extension axis. A substantially flat flap is arranged in the tubular body across the passage section and has a flap section totally within the passage section. A shaft is integral with the flap and is rotatable about a rotation axis that passes through the body and is substantially perpendicular to the extension axis. The flap is rotatable between a closed orientation, in which the flap is provided substantially perpendicular to the extension axis, so as to close off the passage section, and an open orientation, in which the flap is not substantially perpendicular to the extension axis so as to free the passage section, at least partially. A first seat is of substantially hemi-annular shape about the extension axis and is integral with the body. The first seat extends angularly substantially from a first end of the shaft to a second end of the shaft in a trigonometric direction and is delimited by the passage section, on the outside, and by a seat section on the inside, totally within the flap section. The first seat is capable of accommodating, in closed orientation, a first hemi-annular edge of the flap facing each other, arranged on a first face of the flap. A second seat is integral with the body and has substantially hemi-annular shape about the extension axis. The second seat extends angularly substantially from the second end of the shaft to the first end of the shaft in the trigonometric direction. The second seat is delimited by the passage section on the outside and by the seat section on the inside, adapted to receive, in closed orientation, a second hemi-annular edge of the facing flap, arranged on a second face of the flap, opposite the first face. Additionally, for each plane passing through the extension axis, a distal end of a profile of a respective one of the first and second seats is curved in the direction of a facing respective one of the first and second edges until the distal end comes into contact with the respective one of the first or second edges, and a distal end of an edge profile of a respective one of the first and second hemi-annular edges is curved towards a facing a respective one of the first and second seats until the distal end comes into contact with the respective one of the first and second seats, so as to create two points of contact, in closed orientation, between a seat profile and a facing edge profile.

Particular features or embodiments, which may be used alone or in combination, include:
a flap section, in a plane perpendicular to the rotation axis, has an S shape between the first and second hemi-annular edges,
the first and second seats are aligned in a plane perpendicular to the extension axis and passing through the rotation axis, and the flap comprises two half-flaps separated by the shaft, which are flat and preferably parallel to each other, a first half-flap being provided on one side of the plane and a second half-flap being provided on the other side of the plane,
a flap section, in a plane perpendicular to the rotation axis, has a rectilinear shape between the first and second hemi-annular edges,
the body comprises two flanges, substantially symmetrical to each other and arranged symmetrically relative to the plane,
the body also comprises a ring, arranged and held between the two flanges and carrying the first and second seats,
the ring is substantially symmetrical about the rotation axis
the ring, excluding the seat profiles, is flat and parallel to the plane.

In a second aspect of the disclosure, an exhaust line comprising at least one such exhaust valve.

In a third aspect of the disclosure, a vehicle comprising at least one such exhaust line.

### BRIEF DESCRIPTION OF THE DRAWINGS

The disclosure will be better understood from the following description, made only by way of example, and with reference to the appended Figures in which:

FIG. 1 shows one embodiment of an exhaust valve according to the disclosure, in a perspective view,

FIG. 2 shows the exhaust valve of FIG. 1, in an exploded perspective view, and

FIG. 3 shows the flap and the seats, in a cropped view, in to a plane perpendicular to the rotation axis B.

### DETAILED DESCRIPTION

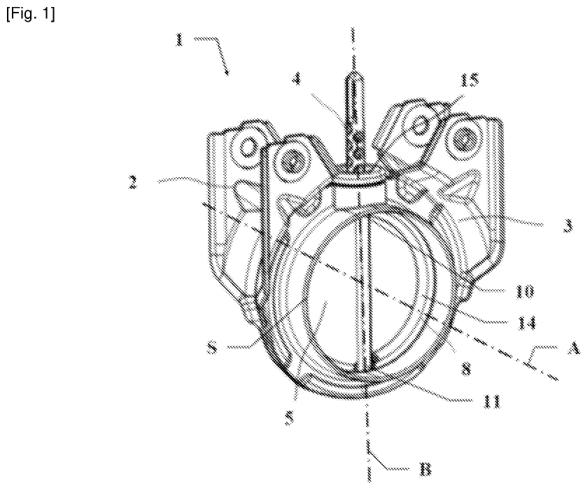

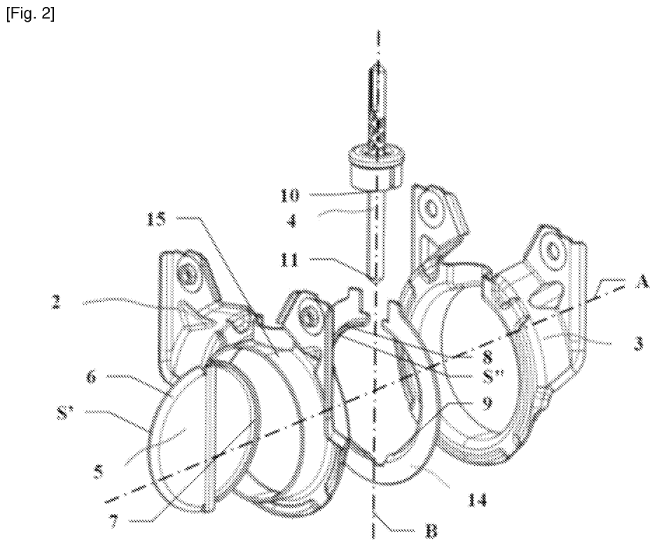

With reference to FIGS. 1 and 2, an exhaust valve 1 according to one embodiment of the disclosure comprises a body 15, a flap 5, a shaft 4, a first seat 8 and a second seat 9.

The valve body 15 is substantially tubular. It extends along an extension axis A. The body 15 defines a passage section S substantially perpendicular to and advantageously centered on the extension axis A. This section can be any shape, but it is preferably elliptical and even more preferably circular.

The flap 5 is substantially flat. It is arranged in the body 15 across the passage section S. It has a flap section S′ totally within the passage section S. Preferably, this flap section S′ reproduces the passage section S with a homotheticity factor close to 1 per lower value.

The shaft 4 is integral with the flap 5. It is rotatable around a rotation axis B. The rotation axis B passes through the body 15 and is substantially perpendicular to the extension axis A. It thus passes substantially in the middle of the body 15. The rotation of the shaft 4, and thus of the integral flap 5, allows the latter to alternate between a closed orientation, where the flap 5 is arranged substantially perpendicular to the extension axis A, so as to close off the passage section S, and an open orientation, where the flap 5 is in another orientation and is not substantially perpendicular to the extension axis A, so as to free the passage section S, at least partially.

The first seat 8 is integral with the body 15. It has a substantially hemi-annular shape, e.g. half-ring shape, around the extension axis A. The said half-ring extends angularly substantially from a first end 10 of the shaft 4 to a second end 11 of the shaft 4 in the trigonometric direction. The shaft 4 and its ends 10, 11 here are considered to be within the body 15 and the passage section S. Thus, even though the shaft may include an extension extending out of the body 15, this extension is considered to be a way of coupling to an actuator, such as a motor, for example, and is not considered to belong to the shaft 4 itself. Also, the two ends 10, 11 of the shaft 4 are located on the contour of the passage section S at the inner periphery of the body 15. Spatially, in a plane substantially perpendicular to the extension axis A, the first seat 8 is delimited on the outside by the passage section S, which it fits in a sealed gas-tight manner, and on the inside by a seat section S″ completely within the flap section S′. Thus, the superposition of the flap 5 with the first seat 8, in closed orientation, has an overlap.

The second seat 9 is integral with the body 15. It has a substantially hemi-annular shape around the extension axis A. The said half-ring extends angularly from the second end 11 of the shaft 4 to the first end 10 of the shaft 4 in the trigonometric direction. Thus, a superposition of the two half-rings in a plane perpendicular to the extension axis A substantially forms a complete ring. Spatially, in a plane substantially perpendicular to the extension axis A, the second seat 9 is limited by the passage section S on the outside, which it fits in a sealed gas-tight manner, and by the seat section S″ on the inside, which is completely within the flap section S′. Also, the superposition of the flap 5 with the second seat 9, in closed orientation, has an overlap.

Preferably, the seat section S″ reproduces the flap section S′ with a homotheticity factor close to 1 per lower value.

The flap 4, has a first hemi-annular edge or border 6 and a second hemi-annular edge or border 7 at its external contour. The first seat 8 is able to receive the first facing hemi-annular edge or border 6, in the closed orientation. The first edge or border 6 is arranged on a first face of the flap 5. The second seat 9 is adapted to receive the second facing edge or border 7, in the closed orientation. The second edge or border 7 is arranged on a second face of the flap 5, opposite to the first face.

Exhaust valves of the prior art most often have flat edges and seats, parallel to each other in the closed orientation, in a plane perpendicular to the extension axis A. Also, the sealing and leak reduction is obtained by a plane/plane contact of the two parts, edge and seat, most often metallic. Such sealing is limited by the extent of the contact surface between the parts. This surface is necessarily limited so as not to reduce the gas flow section too much, mistaken for the seat section S″. The sealing is also limited by the quality of the (co-) planarity, which is not necessarily optimal due to the technologies used to manufacture the components, most often forming or stamping, as well as by the assembly technologies, most often welding or screwing.

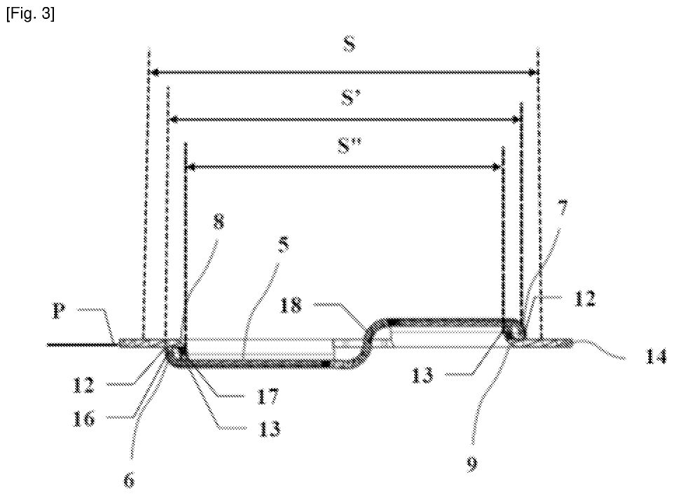

In order to improve the sealing between an edge 6, 7 and a seat 8, 9, according to one feature, the disclosure proposes to modify the terminal profile of the edges 6, 7 and the terminal profile of the seats 8, 9. Also, as more particularly illustrated in FIG. 3, in any plane passing through the extension axis A, the distal end 17, i.e. the free and inner end of the profile of a seat 8, 9 is curved in the direction of the facing edge 6, 7. This curvature is such that the distal end 17 of the profile of the seat 8, 9 comes into contact with the facing edge 6, 7. Symmetrically, the distal end 16, i.e. the free and external end of the profile of an edge 6, 7 is curved in the direction of the facing seat 8, 9, i.e. a curvature in the opposite direction to the previous one. This curvature is such that the distal end 16 of the profile of the edge 6, 7 comes into contact with the facing seat 8, 9. Thus, in closed orientation, two points of contact 12, 13 are created between the profile of a seat 8, 9 and the profile of an opposite edge 6, 7. This configuration also creates a baffle between a seat 8, 9 and an edge 6, 7, effectively opposing gas flow between the two parts. Moreover, such a design ensures an effective seal, even with less precise shaping of the parts. Indeed, the “mutually embracing” shape of the two facing profiles is reproduced and thereby the two contact points 12, 13, even with a dimensional variation in at least one of the two facing parts.

According to another feature, more particularly illustrated in FIG. 3, the section of the flap 5 in a plane perpendicular to the rotation axis B has an S shape 18 between the two edges 6, 7.

Such a shape is advantageous in that it makes it possible to form a flap 5 composed of two half-flaps, each on one side of the shaft 4, these two half-flaps being substantially parallel to each other. Also, in an embodiment where the seats 8, 9 are both substantially aligned in the same plane P perpendicular to the extension axis A and passing through the rotation axis B, a first half-flap is arranged on one side of the plane P, i.e. as illustrated in FIG. 3, below the plane P and thus below a first seat 8 and a second half-flap is arranged on the other side of the plane P, i.e. here above the plane P and thus above a second seat 9. This flatness of the half-flaps, neglecting the thickness of the seats 8, 9 is advantageous in that it makes it possible to align the distal end 16 of the two edges 6, 7, with each other and parallel to the plane P. This makes it possible to make a simple shape of said distal end contour 16 that is flat and parallel to the plane P and thus easier to manufacture.

According to another variant feature (not illustrated), the section of the flap 5 in a plane perpendicular to the rotation axis B has a rectilinear shape between the two edges 6, 7. Such a feature simplifies the manufacture of the flap 5. However, in this case, the main plane of the flap 5 in closed orientation is not perpendicular to the extension axis A, but has a slight angle α. Also, based on the respective positions of the seats 8, 9, the distal end contour 16, i.e. the location of all distal ends 16 of the different profiles of the flap 5 must be adapted. If the seats 8, 9 are kept substantially both aligned in the same plane P, the profile of an edge 6, 7 in a plane passing through the extension axis A must be shortened as one approaches one of the ends 10, 11 of the shaft 4 and, in contrast, lengthened as one moves away from it, to be maximum in the middle. This is to ensure the contact point 12 with the facing seat 8, 9, over the entire contour. In a complementary manner, the profile of a seat 8, 9 in a plane passing through the extension axis A must be lengthened as one approaches one of the ends 10, 11 of the shaft 4 and, in contrast, shortened as one moves away from it, to be minimum in the middle. This is to ensure the point of contact 13 with the facing edge 6, 7, over the entire distal end contour 17, i.e. the location of all the distal ends 17 of the various seat profiles 8, 9.

The calculation of this “correction” of the two respective contours, locations of the ends 16 or 17, is known to the person skilled in the art, based on the angle α, itself determinable based on the positions and curvatures of the seats 8, 9 and the curvatures of the edges 6, 7.

According to another feature, the valve is advantageously made by forming the body 15 by way of two flanges 2, 3 substantially symmetrical to each other and arranged symmetrically relative to the plane P. Each flange 2, 3 is advantageously made by forming or stamping.

According to another feature, the two flanges 2, 3 are identical.

According to another feature, the body 15 also comprises a ring 14 arranged and held between the two flanges 2, 3. The seats 8, 9 can be attached, typically by welding, or can be made of material as shown in FIGS. 1-3. The body 15 is composed of the two flanges 2, 3 and the ring 14, the three parts being assembled by any method: welding, riveting, riveting, crimping, etc.

According to another feature, the ring 14 is substantially symmetrical about the rotation axis B.

According to another feature, as illustrated in FIGS. 1-3, the ring 14 is flat and parallel to the plane P, excluding the profiles of the seats 8, 9, which project from the plane P because of their curvature. This greatly simplifies the design of the ring 14 and thereby the seats 8, 9 and thus the valve 1.

The disclosure also relates to an exhaust line comprising at least one such exhaust valve 1.

The disclosure further relates to a vehicle comprising at least one such exhaust line.

The disclosure has been illustrated and described in detail in the drawings and the preceding description. The latter should be considered as illustrative and given as an example and not as limiting the disclosure to this description alone. Many variant embodiments are possible.

### LIST OF REFERENCES

1: valve,
2: first flange,
3: second flange,
4: shaft,
5: flap,
6: first edge,
7: second edge,
8: first seat,
9: second seat,
10: first shaft end,
11: second shaft end,
12, 13: contact point,
14: ring,
15: body,
16: distal end of an edge profile,
17: distal end of a seat profile,
18: S shape,
A: extension axis,
B: rotation axis,
P: plane,
S: passage section,
S′: flap section,
S″: seat section.

1. An exhaust valve comprising:
a tubular body extending along an extension axis defining a passage section perpendicular to the extension axis;
a planar flap arranged in the tubular body across the passage section and having a flap section totally within the passage section;
a shaft, integral with the planar flap, is rotatable about a rotation axis that passes through the tubular body and is perpendicular to the extension axis, the planar flap being rotatable between a closed orientation where the planar flap is arranged perpendicular to the extension axis so as to close off the passage section and an open orientation where the planar flap is not perpendicular to the extension axis so as to release the passage section, at least partially;
a first seat, integral with the tubular body and having a hemi-annular shape about the extension axis, the first seat extending angularly from a first end of the shaft to a second end of the shaft in a trigonometric direction, the first seat being delimited on an outside by the passage section and on an inside by a seat section completely within the flap section and being capable, in the closed orientation, of receiving a first hemi-annular edge of the planar flap facing the first seat, arranged on a first face of the planar flap; and
a second seat, integral with the tubular body and having a hemi-annular shape about the extension axis, the second seat extending angularly from the second end of the shaft to the first end of the shaft in the trigonometric direction, and the second seat delimited on an outside by the passage section and on an inside by a seat section, and the second seat being capable, in the closed orientation, of accommodating a second hemi-annular edge of the planar flap facing the second seat arranged on a second face of the planar flap, opposite the first face, wherein, in each plane passing through the extension axis, a distal end of a profile of a respective one of the first and second seats is curved in a direction of a respective one of the first and second hemi-annular edges until the distal end comes into contact with the respective one of the first and second hemi-annular edges, and a distal end of a profile of a respective one of the first and second hemi-annular edges is bent in a direction of a respective one of the first and second seats until the distal end comes into contact with the respective one of the first and second seats, so as, in the closed orientation, to create two points of contact between the profile of the respective one of the first and second seats and the profile of the respective one of the first and second hemi-annular edges.

2. The exhaust valve according to claim 1, wherein a section of the planar flap, in a plane perpendicular to the rotation axis, has an S-shape between the first and second hemi-annular edges.

3. The exhaust valve according to claim 2, wherein the first and second seats are aligned in a plane perpendicular to the extension axis and passing through the rotation axis, wherein the planar flap comprises two half-flaps separated by the shaft, which are planar and parallel to each other, a first half-flap being provided on one side of the plane and a second half-flap being provided on the other side of the plane.

4. The exhaust valve according to claim 1, wherein a section of the planar flap has a rectilinear shape between the first and second hemi-annular edges, in a plane perpendicular to the rotation axis.

5. The exhaust valve according to claim 1, wherein the tubular body comprises two flanges symmetrical to each other and symmetrically arranged relative to a plane perpendicular to the extension axis.

6. The exhaust valve according to claim 5, wherein the tubular body further comprises a ring arranged and held between the two flanges and carrying the first and second seats.

7. The exhaust valve according to claim 6, wherein the ring is symmetrical about the rotation axis.

8. The exhaust valve according to claim 6, wherein the ring, excluding profiles of the first and second seats, is flat and parallel to a plane perpendicular to the extension axis.

9. An exhaust line comprising at least one exhaust valve according to claim 1.

10. A vehicle comprising at least one exhaust line according to claim 9.
